(19) United States
(12) Patent Application Publication
(10) Pub. No.: US 2026/0099785 A1
(43) Pub. Date: Apr. 9, 2026

(54) SYSTEMS AND METHODS FOR A SELF-LEARNING, RESILIENT REINFORCEMENT-LEARNING AGENT

(71) Applicant: Kinaxis Inc, Ottawa (CA)

(72) Inventors: Saju Peter, Bengaluru (IN); Loganathan Balasubramani, Chennai (IN); Sudhan MANI, Channai (IN)

(73) Assignee: Kinaxis Inc, Ottawa (CA)

(21) Appl. No.: 19/350,105

(22) Filed: Oct. 6, 2025

Related U.S. Application Data
(60) Provisional application No. 63/704,224, filed on Oct. 7, 2024.

(51) Int. Cl. G06Q 10/0631; G06N 20/00

(52) U.S. Cl. CPC G06Q 10/06314; G06N 20/00

(57) ABSTRACT

Systems and methods for enterprise production scheduling using a self-learning, resilient Reinforcement Learning (RL) agent. The RL agent interacts with a simulated production environment modeled as a dynamic graph, enabling efficient handling of complex multi-stage scheduling dependencies. Through iterative training, inference, and continuous learning modes, the agent autonomously learns optimal scheduling policies, adapts to evolving production conditions, and incorporates user preferences. The system includes components such as a data profiler for historical analysis, a synthesizer for training data generation, and an initializer for environment setup. The RL agent generates multiple feasible schedules, refines its policy based on feedback, and significantly reduces computational overhead compared to traditional heuristics and genetic algorithms.

This application claims priority to U.S. Provisional Patent Application 63/704,224 filed on Oct. 7, 2024, which is incorporated herein in its entirety, by reference.

### BACKGROUND

Enterprise production scheduling (EPS) poses significant challenges due to its NP Hard nature, making it computationally intensive and time-consuming. While heuristics are commonly employed to tackle this complexity, they have their own shortcomings. The shortcomings of heuristics are many, including their limited adaptability, tendency towards suboptimal solutions, reliance on hand-coded scheduler rules, and the absence of user feedback-based performance enhancements, leading to a lack of schedule choices. Multi-stage scheduling exacerbates these issues, further complicating the process. As an alternative approach, Genetic Algorithms (GAs) offer promise, but they too have their limitations. GAs may yield non-deterministic schedules, with slight variations in inputs resulting in drastic changes. Additionally, the generation of schedules using GAs entails longer turnaround times, and like heuristics, multi-stage scheduling remains a challenging task as the time taken increases exponentially. Despite these obstacles, enterprises continue to explore and refine strategies to overcome these challenges and optimize their production scheduling processes.

In addition to the above limitations, both Genetic Algorithms (GAs) and heuristics face further challenges. GAs may struggle with premature convergence, where the algorithm settles on suboptimal solutions before fully exploring the search space. Moreover, the effectiveness of GAs relies heavily on parameter tuning, which can be intricate and time-consuming. Heuristics, on the other hand, often lack the ability to handle complex multi-stage relations.

Given these limitations, there is growing interest in leveraging Reinforcement Learning (RL) based methods to address the challenges of enterprise production scheduling. RL offers a promising avenue by allowing systems to learn optimal scheduling policies through interaction with the environment. By enabling dynamic decision-making and incorporating user feedback mechanisms, RL-based approaches have the potential to overcome the shortcomings of traditional heuristics and GAs.

### BRIEF SUMMARY

Unlike heuristic methods, which may settle for subpar outcomes due to their simplistic decision-making paradigms, RL continuously adapts its strategies, incrementally improving the quality of generated schedules. Moreover, unlike Genetic Algorithms (GAs) and certain heuristic approaches that necessitate intricate parameter tuning, RL operates autonomously, fine-tuning its decision-making processes based on observed rewards and environmental cues, thereby streamlining implementation and bolstering robustness.

The proposed RL solution uses an elegant network graph representation that can effortlessly accommodates multi-stage scheduling dependencies, seamlessly incorporating them into its decision-making framework. By delineating dependencies through graph edges and enforcing penalties for violations, the RL can navigate multi-stage scheduling complexities with finesse, without imposing additional design constraints. This graph may dynamically reflect the real-time status of resources and ongoing tasks, facilitating seamless scheduling updates. Guided by observed environmental states, an RL agent can orchestrate scheduling actions sequentially until all schedulable tasks are planned, exhibiting a keen adaptability to evolving production dynamics.

At the heart of the RL framework lies a reward mechanism. This mechanism may rigorously penalize infractions, such as scheduling on occupied machines or initiating tasks prematurely, while it can simultaneously promote actions that enhance scheduling efficiency, including minimizing idle machine time and job-wait durations. Embedded within this framework are Key Performance Indicators (KPIs), which can assess schedule quality by emphasizing adherence to deadlines, minimizing changeover intervals, and optimizing overall turnaround times.

Training an RL agent can be facilitated through synthetic data generated from historical order distributions, fostering a deep understanding of past scheduling patterns. Armed with this knowledge, an RL agent can generate multiple feasible schedules during inference, ensuring adaptability and flexibility in scheduling decisions. Moreover, an RL model can seamlessly integrate human feedback, and can thus refine its scheduling strategies by discerning affinities between jobs and machines, thus perpetually enhancing performance through reinforcement learning infused with human preference.

Thus, an RL-based approach can improve an enterprise production scheduling process, leveraging dynamic graph representations, sophisticated reward mechanisms, iterative learning paradigms and preference learning to efficiently generate optimized schedules, thereby meeting the demands of modern manufacturing environments. In addition, RL-based solutions improve greatly on the long turnaround times required for schedule generation and multi-stage scheduling. Furthermore, RL-based solutions require far less computational time than GAs. RL-based solutions are able to handle complex multi-stage relations that heuristics cannot.

In one aspect, a computing apparatus is provided, that includes: a processor, and a memory storing instructions that, when executed by the processor, configure the apparatus to: train a reinforcement-learning agent using synthetic training data; initialize a live environment includes a dynamic graph representation of scheduling dependencies; execute an inference mode where the reinforcement-learning agent generates schedules based on environmental states and learned policies; receive user feedback on generated schedules; update a data profiler with transactional data and user preferences; and retrain the reinforcement-learning agent based on the updated data.

The computing apparatus may also include where the live environment includes a graph representation with: nodes representing machines and jobs, edges representing compatibility, dependencies, and scheduling constraints; and attributes including machine availability, job status, and time. The computing apparatus may also include where the reinforcement-learning agent receives rewards based on at least one of: minimizing idle machine time, minimizing job wait time, adherence to due dates, and minimizing changeover time. The computing apparatus may also include where the user feedback includes at least one of: selection of preferred schedules, edits to job-machine assignments, and pinning of tasks to specific machines. The computing apparatus may also include further configured to: detect a truncated inference state, enter a continuous learning mode, and update the reinforcement-learning agent's policy based on the failed environment instance. Other technical features may be readily apparent to one skilled in the art from the following figures, descriptions, and claims.

In one aspect, a non-transitory computer-readable storage medium is provided that stores instructions that, when executed by a processor, cause the processor to: train a reinforcement-learning agent using synthetic data; provide a live environment to the reinforcement-learning agent for inference; generate one or more schedules based on the live environment; receive user feedback on the schedules, update transactional data and user preferences; and retrain the reinforcement-learning agent using the updated data. initialize a live environment includes a dynamic graph representation of scheduling.

The non-transitory computer-readable storage medium may also include where the live environment includes a graph representation with: nodes representing machines and jobs, edges representing compatibility, dependencies, and scheduling constraints; and attributes including machine availability, job status, and time. The non-transitory computer-readable storage medium may also include where the reinforcement-learning agent receives rewards based on at least one of: minimizing idle machine time, minimizing job wait time, adherence to due dates, and minimizing changeover time. The non-transitory computer-readable storage medium may also include where the user feedback includes at least one of: selection of preferred schedules, edits to job-machine assignments, and pinning of tasks to specific machines. The non-transitory computer-readable storage medium may also include further includes instructions that, when executed, cause the processor to: detect a truncated inference state, enter a continuous learning mode, and update the reinforcement-learning agent's policy based on the failed environment instance. Other technical features may be readily apparent to one skilled in the art from the following figures, descriptions, and claims.

In one aspect, a computer-implemented method is provided, that includes: training, by a processor, a reinforcement-learning (RL) agent using synthetic data; providing, by the processor, a live environment to the RL agent, the environment including a dynamic graph representation of scheduling dependencies; entering, by the processor, into an inference mode where the RL agent interacts with the live environment to generate one or more schedules; outputting, by the processor, at least one schedule to a user; receiving, by the processor, user feedback includes schedule selection or edits; updating, by the processor, transactional data and user preferences based on the feedback; and retraining, by the processor, the RL agent using the updated transactional data and preferences.

The computer-implemented method may also include where the live environment includes a graph representation with: nodes representing machines and jobs, edges representing compatibility, dependencies, and scheduling constraints; and attributes including machine availability, job status, and time. The computer-implemented method may also include where the reinforcement-learning agent receives rewards based on at least one of: minimizing idle machine time, minimizing job wait time, adherence to due dates, and minimizing changeover time. The computer-implemented method may also include where user feedback includes at least one of: selection of preferred schedules, edits to job-machine assignments, and pinning of tasks to specific machines. The computer-implemented method may also further include: detecting a truncated inference state; entering a continuous learning mode; and updating the reinforcement-learning agent's policy based on the failed environment instance. Other technical features may be readily apparent to one skilled in the art from the following figures, descriptions, and claims.

The details of one or more embodiments of the subject matter of this specification are set forth in the accompanying drawings and the description below. Other features, aspects, and advantages of the subject matter may become apparent from the description, the drawings, and the claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example of a system for a self-learning, resilient Reinforcement-Learning agent in accordance with one embodiment.

FIG. 2 illustrates a system architecture diagram in accordance with one embodiment.

FIG. 3 illustrates an RL Agent in accordance with one embodiment.

FIG. 4 illustrates an environment in accordance with one embodiment.

FIG. 5 illustrates a portion of the environment shown in FIG. 4.

FIG. 6 illustrates another portion of the environment shown in FIG. 4.

FIG. 7 illustrates a Data Profiler in accordance with one embodiment.

FIG. 8 illustrates an aspect of the subject matter in accordance with one embodiment.

FIG. 9 illustrates a system architecture in accordance with one embodiment.

FIG. 10 illustrates a block diagram in accordance with one embodiment.

FIG. 11 illustrates training mode of a reinforcement-learning agent in accordance with one embodiment.

FIG. 12 illustrates Training mode of an environment in accordance with one embodiment.

FIG. 13 illustrates inference mode of a reinforcement-learning agent in accordance with one embodiment.

FIG. 14 illustrates Inference mode of an environment in accordance with one embodiment.

FIG. 15 illustrates continuous learning mode of a reinforcement-learning agent in accordance with one embodiment.

FIG. 16 illustrates Continuous Learning mode of an environment in accordance with one embodiment.

### DETAILED DESCRIPTION

Aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable storage media having computer readable program code embodied thereon.

Many of the functional units described in this specification have been labeled as modules, in order to emphasize their implementation independence. For example, a module may be implemented as a hardware circuit including custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, include one or more physical or logical blocks of computer instructions which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable storage media.

Any combination of one or more computer readable storage media may be utilized. A computer readable storage medium may be, for example, but not limited to, an electronic, magnetic, optical, electromagnetic, infrared, or semiconductor system, apparatus, or device, or any suitable combination of the foregoing.

More specific examples (a non-exhaustive list) of the computer readable storage medium can include the following: a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), a Blu-ray disc, an optical storage device, a magnetic tape, a Bernoulli drive, a magnetic disk, a magnetic storage device, a punch card, integrated circuits, other digital processing apparatus memory devices, or any suitable combination of the foregoing, but would not include propagating signals. In the context of this document, a computer readable storage medium may be any tangible medium that can contain, or store a program for use by or in connection with an instruction execution system, apparatus, or device.

Computer program code for carrying out operations for aspects of the present disclosure may be written in any combination of one or more programming languages, including an object oriented programming language such as Java, Python, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “including,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the disclosure may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the disclosure. However, the disclosure may be practiced without one or more of the specific details, or with other methods, components, materials, and so forth. In other instances, well-known structures, materials, or operations are not shown or described in detail to avoid obscuring aspects of the disclosure.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function/act specified in the schematic flowchart diagrams and/or schematic block diagrams block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present disclosure. In this regard, each block in the schematic flowchart diagrams and/or schematic block diagrams may represent a module, segment, or portion of code, which includes one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer instructions.

The description of elements in each figure may refer to elements of proceeding figures. Like numbers refer to like elements in all figures, including alternate embodiments of like elements.

A computer program (which may also be referred to or described as a software application, code, a program, a script, software, a module or a software module) can be written in any form of programming language. This includes compiled or interpreted languages, or declarative or procedural languages. A computer program can be deployed in many forms, including as a module, a subroutine, a stand-alone program, a component, or other unit suitable for use in a computing environment. A computer program can be deployed to be executed on one computer or can be deployed on multiple computers that are located at one site or distributed across multiple sites and interconnected by a communication network.

As used herein, a “software engine” or an “engine,” refers to a software implemented system that provides an output that is different from the input. An engine can be an encoded block of functionality, such as a platform, a library, an object or a software development kit (“SDK”). Each engine can be implemented on any type of computing device that includes one or more processors and computer readable media. Furthermore, two or more of the engines may be implemented on the same computing device, or on different computing devices. Non-limiting examples of a computing device include tablet computers, servers, laptop or desktop computers, music players, mobile phones, e-book readers, notebook computers, PDAs, smart phones, or other stationary or portable devices.

The processes and logic flows described herein can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). For example, the processes and logic flows that can be performed by an apparatus, can also be implemented as a graphics processing unit (GPU).

Computers suitable for the execution of a computer program include, by way of example, general or special purpose microprocessors or both, or any other kind of central processing unit. Generally, a central processing unit receives instructions and data from a read-only memory or a random access memory or both. A computer can also include, or be operatively coupled to receive data from, or transfer data to, or both, one or more mass storage devices for storing data, e.g., optical disks, magnetic, or magneto optical disks. It should be noted that a computer does not require these devices. Furthermore, a computer can be embedded in another device. Non-limiting examples of the latter include a game console, a mobile telephone a mobile audio player, a personal digital assistant (PDA), a video player, a Global Positioning System (GPS) receiver, or a portable storage device. A non-limiting example of a storage device include a universal serial bus (USB) flash drive.

Computer readable media suitable for storing computer program instructions and data include all forms of non-volatile memory, media and memory devices; non-limiting examples include magneto optical disks; semiconductor memory devices (e.g., EPROM, EEPROM, and flash memory devices); CD ROM disks; magnetic disks (e.g., internal hard disks or removable disks); and DVD-ROM disks. The processor and the memory can be supplemented by, or incorporated in, special purpose logic circuitry.

To provide for interaction with a user, embodiments of the subject matter described herein can be implemented on a computer having a display device for displaying information to the user and input devices by which the user can provide input to the computer (for example, a keyboard, a pointing device such as a mouse or a trackball, etc.). Other kinds of devices can be used to provide for interaction with a user. Feedback provided to the user can include sensory feedback (e.g., visual feedback, auditory feedback, or tactile feedback). Input from the user can be received in any form, including acoustic, speech, or tactile input. Furthermore, there can be interaction between a user and a computer by way of exchange of documents between the computer and a device used by the user. As an example, a computer can send web pages to a web browser on a user's client device in response to requests received from the web browser.

Embodiments of the subject matter described in this specification can be implemented in a computing system that includes: a front end component (e.g., a client computer having a graphical user interface or a Web browser through which a user can interact with an implementation of the subject matter described herein); or a middleware component (e.g., an application server); or a back end component (e.g. a data server); or any combination of one or more such back end, middleware, or front end components. The components of the system can be interconnected by any form or medium of digital data communication, e.g., a communication network. Non-limiting examples of communication networks include a local area network (“LAN”) and a wide area network (“WAN”).

The computing system can include clients and servers. A client and server are generally remote from each other and typically interact through a communication network. The relationship of client and server arises by virtue of computer programs running on the respective computers and having a client-server relationship to each other.

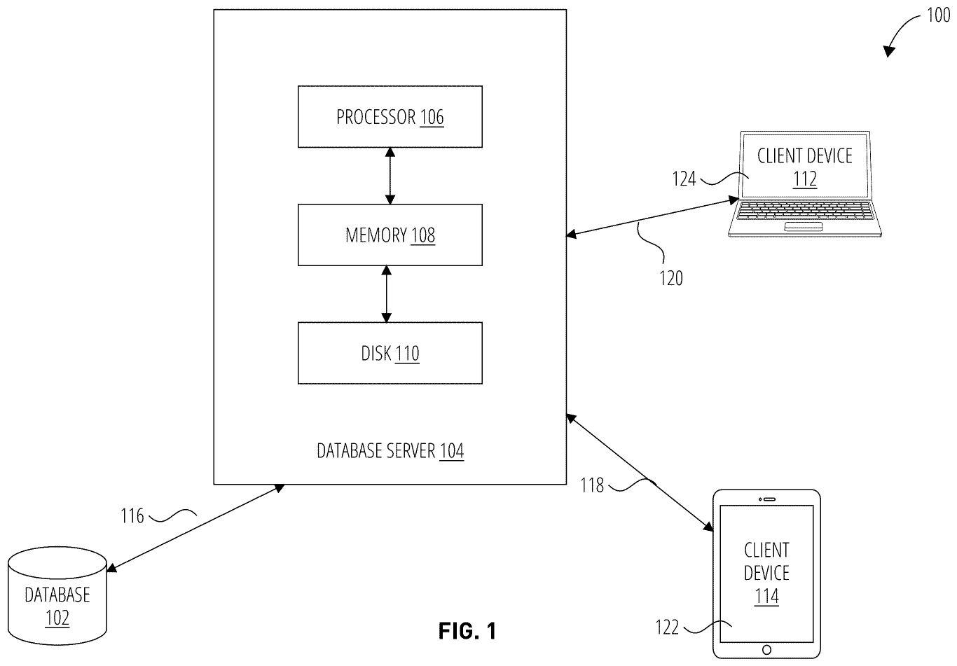

FIG. 1 illustrates an example of a system 100 for a self-learning resilient Reinforcement-learning agent

System 100 includes a database server 104, a database 102, and client devices 112 and 114. Database server 104 can include a memory 108, a disk 110, and one or more processors 106. In some embodiments, memory 108 can be volatile memory, compared with disk 110 which can be non-volatile memory. In some embodiments, database server 104 can communicate with database 102 using interface 116. Database 102 can be a versioned database or a database that does not support versioning. While database 102 is illustrated as separate from database server 104, database 102 can also be integrated into database server 104, either as a separate component within database server 104, or as part of at least one of memory 108 and disk 110. A versioned database can refer to a database which provides numerous complete delta-based copies of an entire database. Each complete database copy represents a version. Versioned databases can be used for numerous purposes, including simulation and collaborative decision-making.

System 100 can also include additional features and/or functionality. For example, system 100 can also include additional storage (removable and/or non-removable) including, but not limited to, magnetic or optical disks or tape. Such additional storage is illustrated in FIG. 1 by memory 108 and disk 110. Storage media can include volatile and nonvolatile, removable and non-removable media implemented in any method or technology for storage of information such as computer-readable instructions, data structures, program modules or other data. Memory 108 and disk 110 are examples of non-transitory computer-readable storage media. Non-transitory computer-readable media also includes, but is not limited to, Random Access Memory (RAM), Read-Only Memory (ROM), Electrically Erasable Programmable Read-Only Memory (EEPROM), flash memory and/or other memory technology, Compact Disc Read-Only Memory (CD-ROM), digital versatile discs (DVD), and/or other optical storage, magnetic cassettes, magnetic tape, magnetic disk storage or other magnetic storage devices, and/or any other medium which can be used to store the desired information and which can be accessed by system 100. Any such non-transitory computer-readable storage media can be part of system 100.

System 100 can also include interfaces 116, 118 and 120. Interfaces 116, 118 and 120 can allow components of system 100 to communicate with each other and with other devices. For example, database server 104 can communicate with database 102 using interface 116. Database server 104 can also communicate with client devices 112 and 114 via interfaces 120 and 118, respectively. Client devices 112 and 114 can be different types of client devices; for example, client device 112 can be a desktop or laptop, whereas client device 114 can be a mobile device such as a smartphone or tablet with a smaller display. Non-limiting example interfaces 116, 118 and 120 can include wired communication links such as a wired network or direct-wired connection, and wireless communication links such as cellular, radio frequency (RF), infrared and/or other wireless communication links. Interfaces 116, 118 and 120 can allow database server 104 to communicate with client devices 112 and 114 over various network types. Non-limiting example network types can include Fibre Channel, small computer system interface (SCSI), Bluetooth, Ethernet, Wi-fi, Infrared Data Association (IrDA), Local area networks (LAN), Wireless Local area networks (WLAN), wide area networks (WAN) such as the Internet, serial, and universal serial bus (USB). The various network types to which interfaces 116, 118 and 120 can connect can run a plurality of network protocols including, but not limited to Transmission Control Protocol (TCP), Internet Protocol (IP), real-time transport protocol (RTP), realtime transport control protocol (RTCP), file transfer protocol (FTP), and hypertext transfer protocol (HTTP).

Using interface 116, database server 104 can retrieve data from database 102. The retrieved data can be saved in disk 110 or memory 108. In some cases, database server 104 can also include a web server, and can format resources into a format suitable to be displayed on a web browser. Database server 104 can then send requested data to client devices 112 and 114 via interfaces 120 and 118, respectively, to be displayed on applications 122 and 124. Applications 122 and 124 can be a web browser or other application running on client devices 112 and 114.

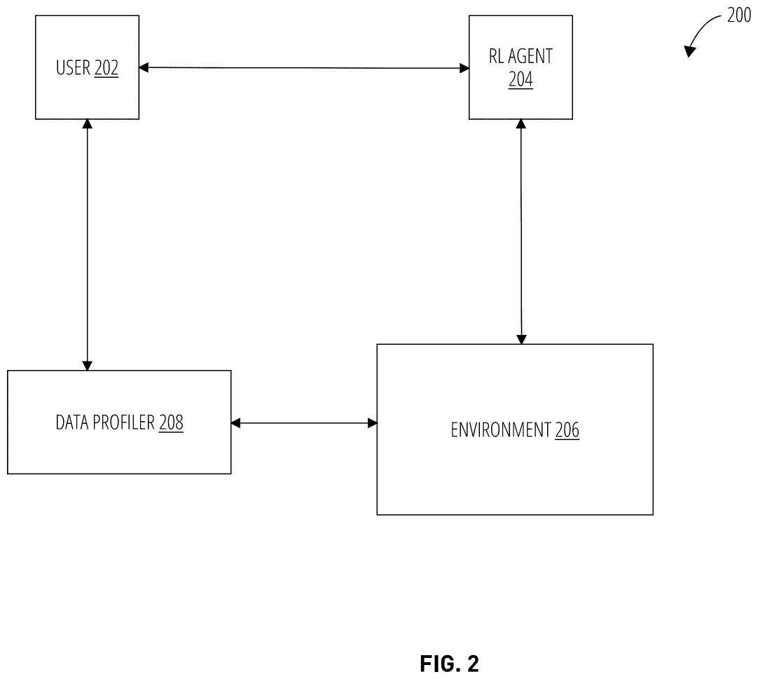

FIG. 2 illustrates a system architecture diagram 200 in accordance with one embodiment. In FIG. 2, a system architecture can include: a user 202, a Reinforcement Learning Agent 204, an Environment 206, and a Data profiler 208. An embodiment of each of these elements is described further below.

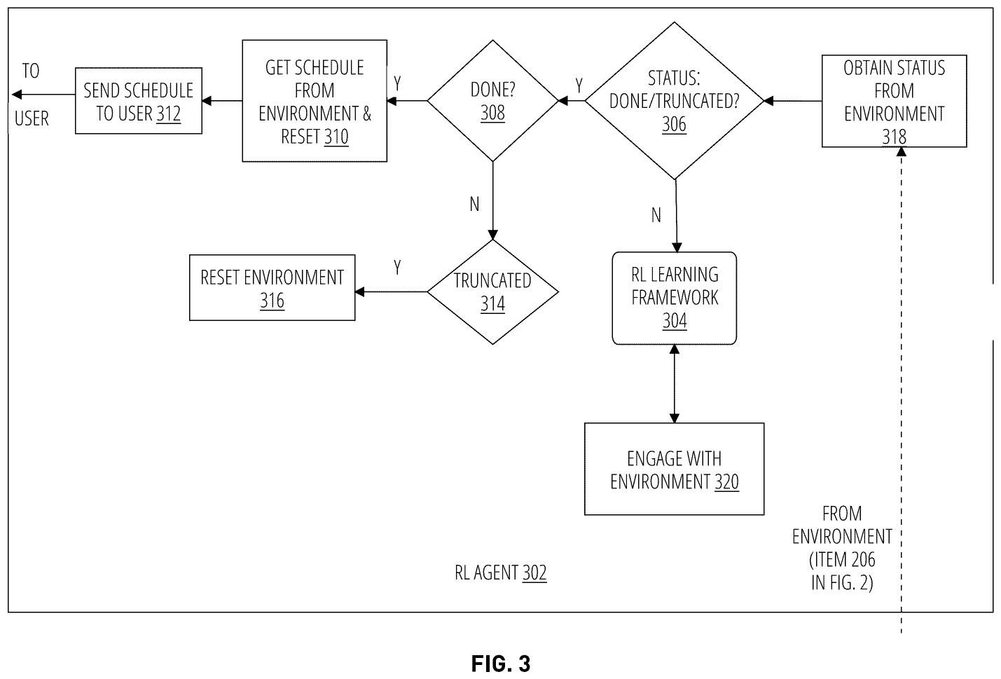

FIG. 3 illustrates a RL Agent 302 in accordance with one embodiment. RL Agent 302 is tasked with scheduling jobs in a given environment. This environment can provide the RL Agent 302 with a list of jobs and due time targets. The RL Agent 302 can utilize a RL Learning Framework 304 such as Deep Q-Learning (DQN) or Proximal Policy Optimization (PPO), to interact with the environment at block 320 and learn a policy for scheduling these jobs efficiently.

During its interaction with the Environment 206, the RL Agent 302 may receive feedback in the form of rewards and different statuses (see block 318). The status can be in one of the following forms: ‘Done’, ‘Truncated’, or ‘InProgress’.

When the status is ‘Done’ (‘yes’ at both decision block 306 and decision block 308), it means the Environment 206 has successfully executed the order and produced a schedule. The RL Agent 302 receives a schedule (block 310) from Environment 206, resets the Environment 206, and prepares for the next variation of the schedule.

When the status is ‘Truncated’ (‘yes’ at decision block 306 and ‘no’ at decision block 308), it means the Environment 206 cannot complete scheduling the order. The RL Agent 302 resets the Environment 206 for another attempt at block 316.

When the status is ‘InProgress’ (‘no’ at decision block 306), the RL Agent 302 can utilize a RL Learning Framework 304 to interact with the environment at block 320 and learn a policy for scheduling these jobs efficiently. As an example, the RL Agent 302 can select an action based on its current policy and the state of Environment 206. The RL Agent 302 can take two types of actions: ‘schedule’ and ‘time-forward’. ‘Schedule’ instructs the Environment 206 to schedule a specific job on a particular machine, while ‘time-forward’ advances the environment's clock by a pre-set amount. In an embodiment, the pre-set amount is one time unit. These actions may be taken based on the RL agent's current policy and state of the Environment 206. The Environment 206 returns a reward against the action executed by the RL Agent 302. The RL Agent 302 may then update its policy in response to this reward received.

Additionally, the RL Agent 302 can maintain a record of successful schedules for each order, which it can presents to a user at block 312. The user is then free to choose or edit any of the presented schedules.

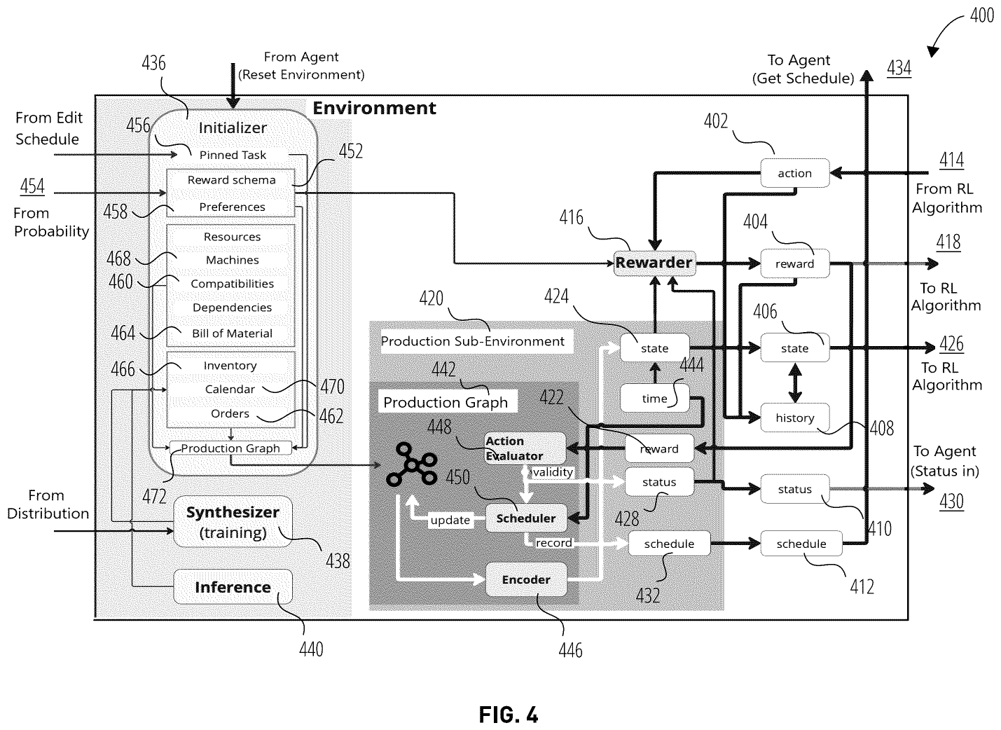

FIG. 4 illustrates an Environment 400 in accordance with one embodiment.

The Environment 400 may constitute a system designed for training and operationalizing a RL agent tasked with scheduling jobs in a production floor (for example, the RL Agent 204 shown in FIG. 2, or the RL Agent 302 shown in FIG. 3).

Environment 400 can include several interconnected components, each playing a role in an RL agent's learning process and decision-making. A key aspect of the Environment 400 is its attributes, a few of which are shown in FIG. 4. These attributes can include: action 402, reward 404, state 406, history 408, status 410, and schedule 412. Environment 400 can include fewer, more or different attributes than action 402, reward 404, state 406, history 408, status 410, and schedule 412. The attributes of Environment 400 shown in FIG. 4 are now briefly described.

Action 402 indicates a current action of the RL Agent. That is, the RL Agent sends a current action to action 402 (indicated by arrow 414). The RL Agent can send this information from an RL algorithm within the RL Agent. Furthermore, action 402 can relay an action to rewarder 416 and history 408.

Reward 404 indicates a reward associated with the current action 402. Reward 404 is also sent to history 408 and the RL Agent (indicated by arrow 418). The RL Agent can receive this information via an RL algorithm within the RL Agent. It can also be sent to the production sub-environment 420 at reward 422.

State 406 may be a vectorized representation of the environment's current state. It can be obtained from production sub-environment 420 at state 424. The environment's current state (406) may be sent to the RL Agent (indicated by arrow 426). The RL Agent can receive this information via an RL algorithm within the RL Agent. State 406 can also interact with history 408. In Environment 400, the state 406 may be further enriched with historical records before being consumed by the RL agent to determine the next state. History 408 can include records of all states since initialization. It may receive information from both state 406 and action 402.

Status 410 may be an indication of whether the environment's task is ‘Done’, ‘Truncated’, or ‘InProgress’ (from status 428 in Environment 400). Status 410 is sent to the RL Agent (indicated by arrow 430).

Schedule 412 indicates schedule steps taken thus far towards fulfilling a current order. It is obtained from Schedule 432 in Environment 400. The schedule is sent to the RL Agent (indicated by arrow 434).

Furthermore, Environment 400 encompasses various sub-components which are used for simulating and interacting with the production floor representation. Some of these sub-components include production sub-environment 420, rewarder 416, initializer 436, synthesizer 438, inference 440 and production graph 442. These are described as follows.

Production sub-environment 420 is a core sub-environment that encapsulates attributes as well as a production graph 442 subcomponent. These attributes can include state 424, time 444, reward 422, status 428 and schedule 432. The attributes and production graph 442 represent a current snapshot of the production floor. In the embodiment shown in FIG. 4, state 424 can be informed by the output of time 444 and the output of encoder 446. Output of state 424 can also inform the rewarder 416 and state 406. Reward 422 in production sub-environment 420 can be obtained from the output of reward 404 of Environment 400. Output of reward 422 can also inform the action evaluator 448 of the production graph 442. Output of status 428 of production sub-environment 420 can inform status 410 of Environment 400, as well as rewarder 416. Status 428 can be informed by the output of action evaluator 448 of production graph 442. The output of schedule 432 (of production sub-environment 420) can inform schedule 412 (of Environment 400). Furthermore, schedule 432 can be informed by the output of scheduler 450 of production sub-environment 420.

The production graph 442 represents the structure and dynamics of the production floor. Production graph 442 may constitute: Node Representation, in which machines and job types are represented as nodes; Edge Interactions, in which edges represent interactions, such as compatibility and dependencies; Status Attributes, which can include machine availability, job status, and other relevant attributes; and Job Assignment, in which edge information reflects job assignments to machines. Other modules can be associated with the production graph 442 subcomponent. Examples include an action evaluator 448, a scheduler 450, and an encoder 446.

Action evaluator 448 can determine the validity of a current action based on the reward returned by the rewarder 416. Action evaluator 448 can also switch the status of the environment to ‘Done’ or ‘Truncated’ based on the reward returned by rewarder 416. Output of action evaluator 448 can inform scheduler 450.

Scheduler 450 may schedule a job to a machine if determined valid by the action evaluator 448. Scheduler 450 can also track when the job completes execution; scheduler 450 can then update the graph edges and node attributes accordingly. The scheduler 450 can also update the record of these schedule steps which are then forwarded to the RL agent on a successful schedule (see arrow 434).

Encoder 446 can flatten graph nodes, its attributes and edges into a vector representation. This vector representation may then be added to the production sub-environment state 424. The production sub-environment 420 can then add information about time 444 to the state 424.

Rewarder 416 is responsible for assigning one or more rewards to actions taken by the RL agent. The reward is based on a reward configuration (also termed as “reward schema 452”), current state 424 of the production sub-environment 420, and current action performed by the RL agent on the environment. The current action of the RL agent is indicated by arrow 418, which is input to action 402, which is sent to rewarder 416. Status 428 of the production sub-environment 420 can also be input to the rewarder 416.

Initializer 436 is responsible for setting up the Environment 400, production graph 442 and initializing other parameters required for scheduling. Initializer 436 is described further below.

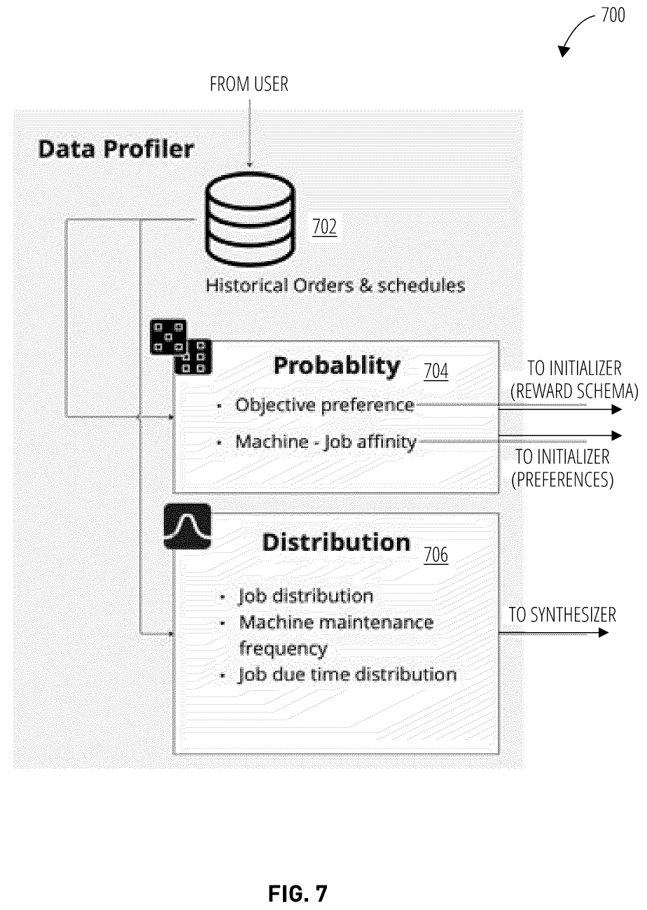

Synthesizer 438 generates training data for the RL agent. It's input can be informed by distribution data in the data profiler (see FIG. 7).

Finally, Inference 440 facilitates scheduling based on learned policy.

The initializer 436 can instantiate many attributes which are central to enterprise scheduling. Input to initializer 436 can be informed from the RL Agent (see FIG. 3) A few attributes of initializer 436, shown in FIG. 4, are described as follows. It should be noted that initializer 436 can include fewer, more, or different attributes than those shown in FIG. 4.

Reward schema 452, which is a configuration that can determine the reward to be returned in response to an RL agent action based on a current environment state. Reward schema 452 can obtain input from the probability component (see arrow 454) of the data profiler (see FIG. 7).

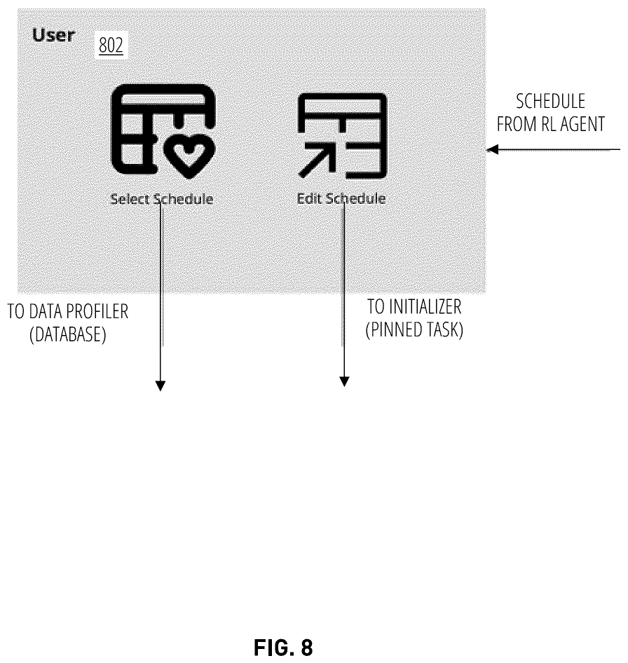

Pinned task 456 refers to tasks pinned or locked in place by a user that will not be moved by the scheduler while preparing a schedule. Preferences 458 can also be informed by a user who can edit an output schedule (see FIG. 8).

With respect to Preferences 458, some job-machine combinations are preferred more than other compactible combinations. Also, some production objectives are preferred over others (for example: due-time-miss over change over). Preferences 458 can receive input from the machine/job affinity component of the data profiler (see FIG. 7).

For Compatibilities 460, every operation has a specific resource (for example, machine, labour) that it has to consume or to be scheduled on with a specific start time and an end time of the operation.

Orders 462 refer to manufacturing orders that need to be broken down into schedulable entities called work items and then into operations. The operations are then scheduled on resources.

Bill of Materials 464 refers to components that are consumed in their respective quantities in order to produce per unit of the end item.

Inventory 466 refers to on-hand stock of raw materials, components, semi-finished goods or finished goods.

Machines 468 are the resources in which the jobs will be scheduled on.

Calendar 470 refers to several types of calendars that can be used by the initializer 436. For example, an availability calendar defines when a machine (or labour) will be available for work. Down time calendars define the holidays or shutdowns that happen to a single resource or a group of resources for various reasons.

The initializer 436 can also instantiate the production graph 472 based on the above parameters. For the learning to commence and proceed to successful scheduling, the various components in the initializer 436 (described above) are first set appropriately.

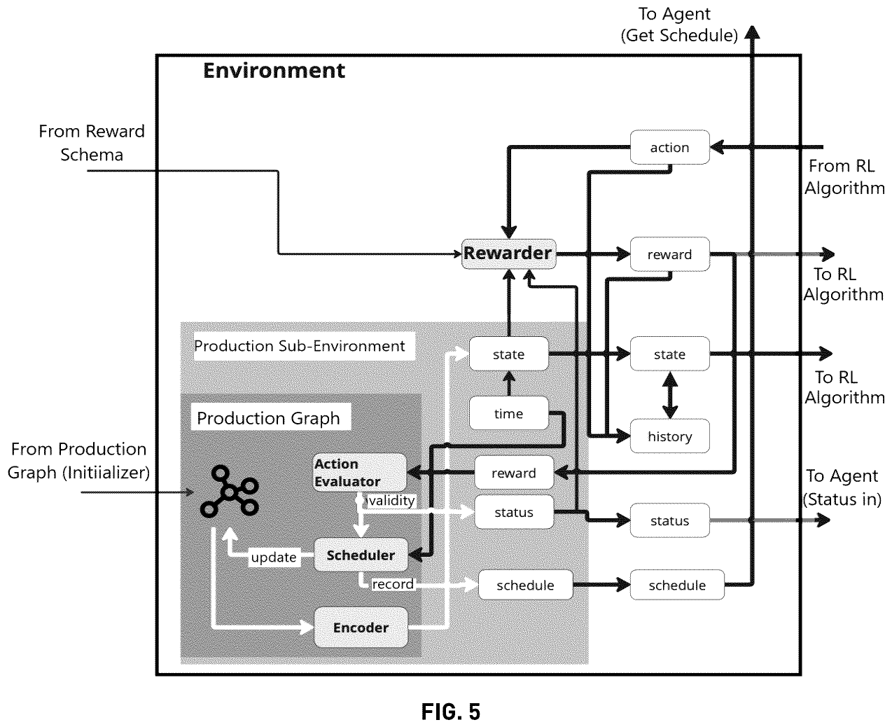

FIG. 5 illustrates a portion of the Environment 400 shown in FIG. 4. This illustration provides an enlargement of a part of the Environment 400 shown in FIG. 4, for greater clarity.

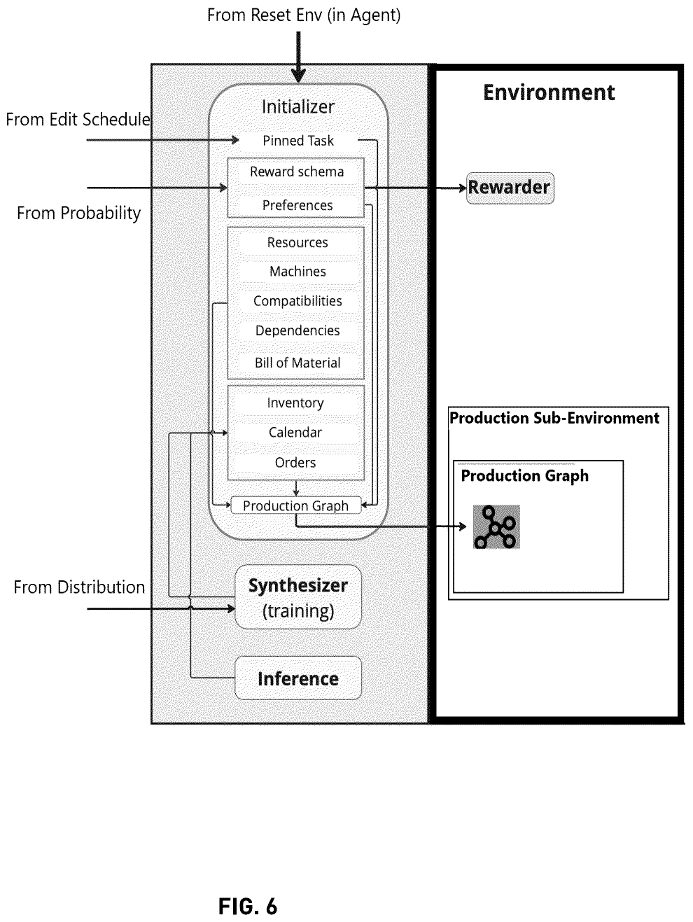

FIG. 6 illustrates another portion of the Environment 400 shown in FIG. 4. This illustration provides an enlargement of the initializer 436, rewarder 416 and production sub-environment 420 of the Environment 400 shown in FIG. 4, for greater clarity.

FIG. 7 illustrates a Data Profiler 700 in accordance with one embodiment. Data Profiler 700 is a component that can learn a distribution over historical order and schedules. Database 702 can store historical orders and schedules. Data Profiler 700 can be instrumental in learning and adapting an RL agent's policy influenced by user preferences.

The distribution may include probability scores for machine-job affinity and objective preference, shown in box 704. These scores can then be used to set the preferences parameter in the initializer. In particular, an objective preference can inform an input to the reward schema in the initializer (see synthesizer 438 in FIG. 4), while machine-job affinity can inform the preferences feature in the initializer (see initializer 436 in FIG. 4). They may also be instrumental in rewarding one objective more than another, and thus can influence future schedule generations.

The data profiler can also compute distributions for various other initializer parameters, such as: number of jobs per type, machine availability, distribution of due time in an order, and so forth. This is illustrated in box 706. The distributions can then be sampled by a Synthesizer module (for example, Synthesizer 438 (in FIG. 4) to generate training data during a training cycle.

FIG. 8 illustrates an aspect of the subject matter in accordance with one embodiment. In the embodiment shown in FIG. 8, there are two touch points that a user 802 can interact with the system shown in FIG. 2. User 802 can select one of the schedules provided by the RL agent to put to action on a production floor. The selected schedules may then be added to a database of historical orders and schedules (see, for example, Database 702).

In addition, user 802 can edit the schedule received from the RL agent. For example, user 802 can move jobs around in the schedule. These edited jobs in the schedule can then be pinned in the initializer and resubmitted to the RL agent for regeneration.

As described above in FIG. 2-FIG. 8, a Reinforcement-Learning solution is centered around a RL Agent 204 and an Environment 206. The Environment 206 is initialized to reflect the production floor and order instance. The RL Agent 204 can then be trained to learn a policy on how to schedule an order over various environment instances. The policy can dictate and action the RL Agent 204 takes, by observing the current state of the environment. The environment reacts to the action by updating a production graph 472 (see FIG. 4), various other environment attributes and it's state. The environment (206, 400) can also return a reward to the RL Agent 204 in response to the executed action. The reward scheme is setup such that it encourages scheduling steps that optimize the scheduling objectives while penalizing incorrect or sub-optimal steps. By virtue of this training, the RL Agent 204 learns to schedule a given arbitrary order during inference. The RL Agent 204 is typically setup to generate more than one schedule against an order. The solution also learns from user interaction with these generated schedules. The user can select one of many generated schedules and might also choose to edit them. The solution tracks these user choices across many schedules and learns a distribution of user preferences. The preferences can be ingested into the environment and the RL Agent 204 may then update its learnt policy to favour these preferences in subsequent training cycles, thus adapting to user preferences.

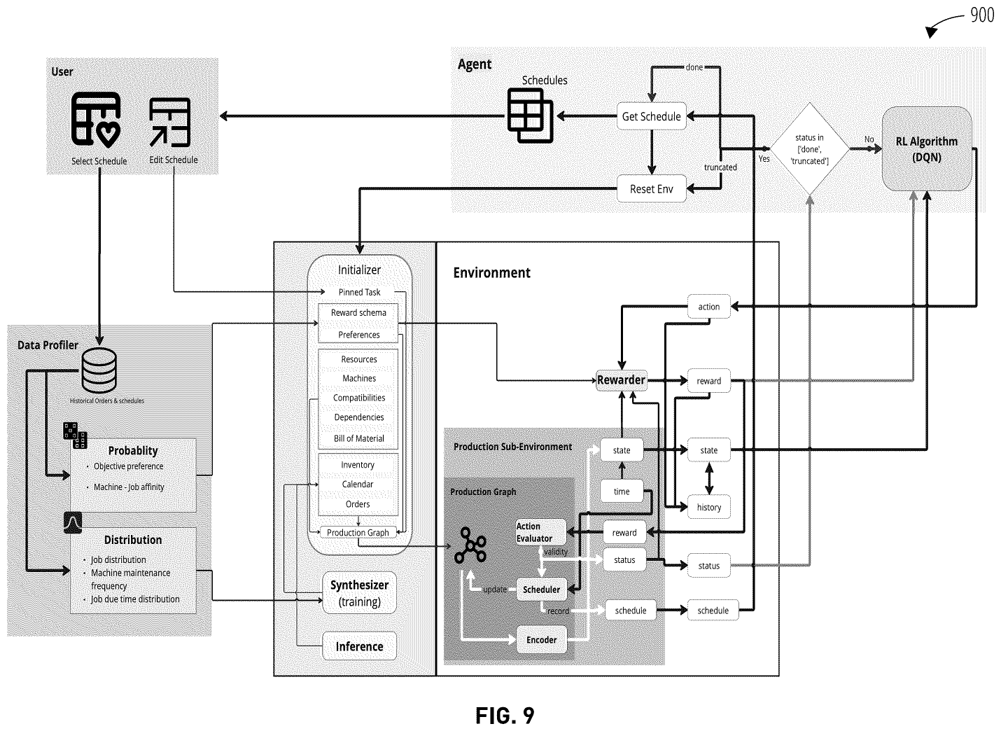

FIG. 9 illustrates a system architecture 900 in accordance with one embodiment. FIG. 9 is a composite of FIG. 3, FIG. 4, FIG. 7 and FIG. 8, and as such, shows an embodiment of the system shown in FIG. 2.

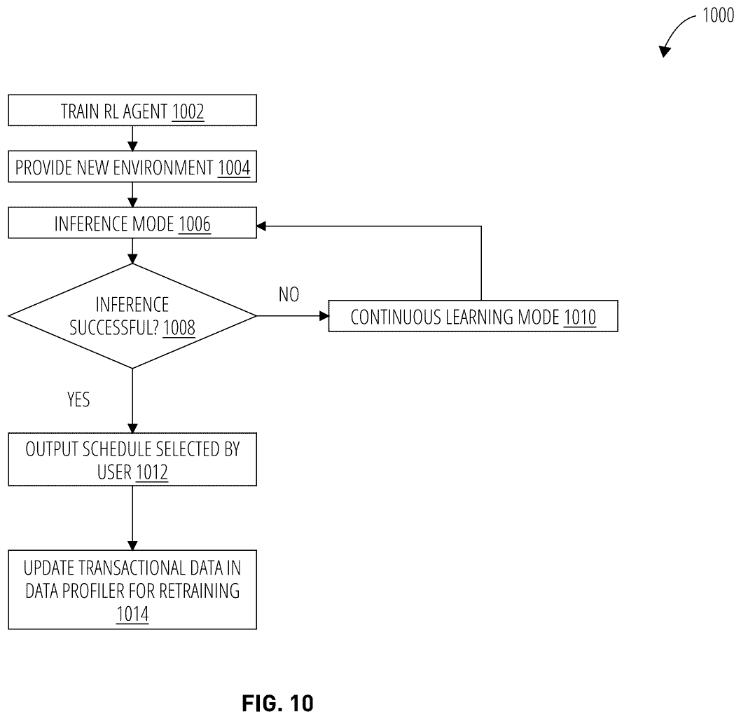

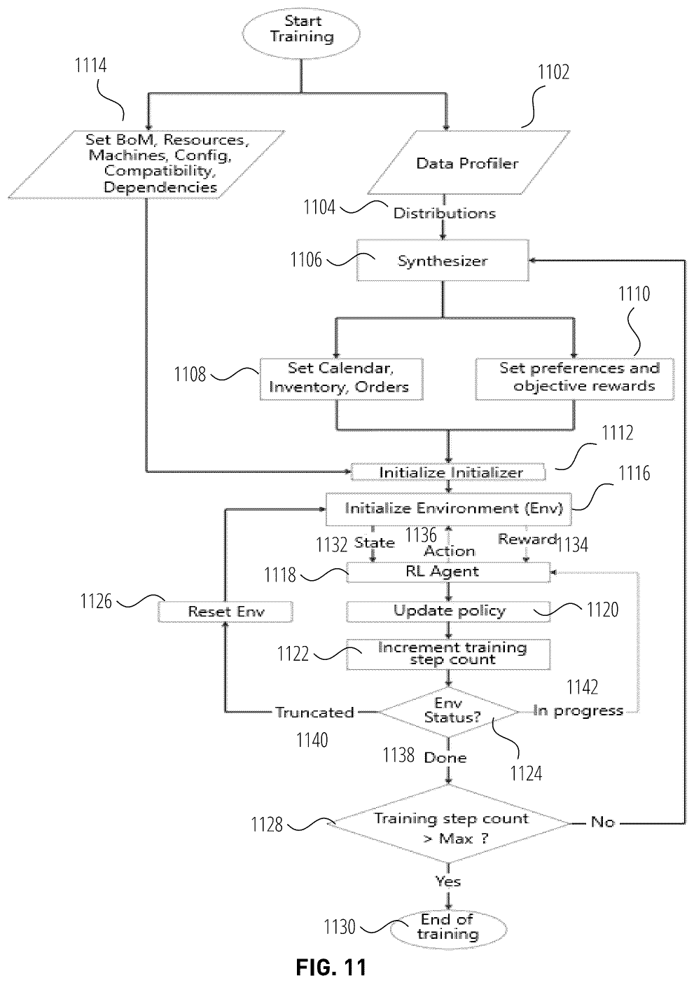

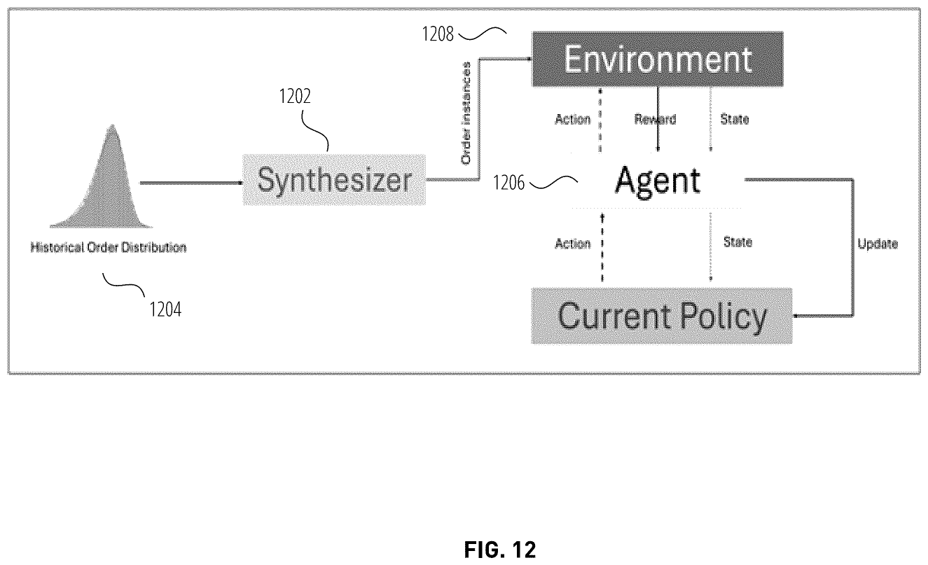

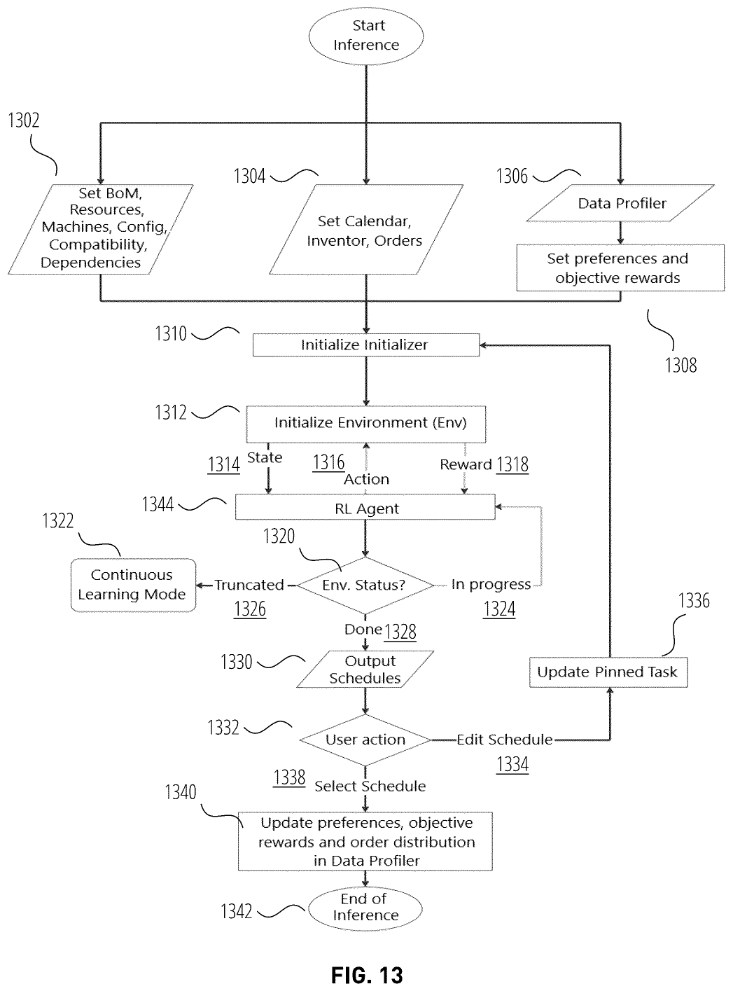

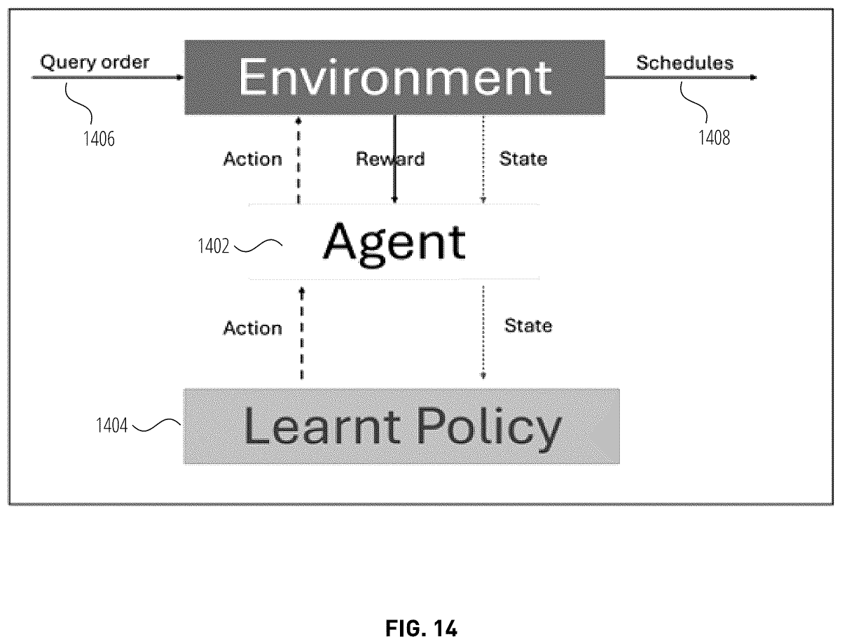

FIG. 10 illustrates a block diagram 1000 in accordance with one embodiment. At block 1002, an RL Agent is trained. An embodiment of the training process is illustrated and further described in FIG. 11 and FIG. 12. Thereafter, a new environment is provided to the RL Agent at block 1004, in order to provide a schedule. The system then enters an inference mode at block 1006. An embodiment of the inference mode is illustrated and further described in FIG. 13 and FIG. 14.

If the inference is unsuccessful for the new environment (‘no’ at decision block 1008), then the system enters a continuous learning mode at block 1010. An embodiment of the inference mode is illustrated and further described in FIG. 13 and FIG. 14. After block 1010, the system returns to the inference mode at 1006, until the inference is successful.

When the inference is successful for the new environment (‘yes’ at decision block 1008), then a schedule is output to a user. The user can edit the schedule until they are satisfied, or accept the initial output provided by the inference mode. This is further described in FIG. 13. Either way, once a schedule is selected to the satisfaction of the user at block 1012, transactional data is updated in the data profiler for retraining the RL agent, at 1014.

There are three modes at which the Environment 400 can operate: Training mode, Inference mode and Continuous Learning mode. Each mode is described below.

FIG. 11 illustrates training mode of a reinforcement-learning agent in accordance with one embodiment.

Training the reinforcement-learning agent can include exposing the agent to environments which it will see in a production system. A Synthesizer 1106 creates such environments for training of the agent, from Distributions 1104, which in turn, are set up from historical data. The synthesizer samples those distributions; each sample is representative of a potential environment that the agent may encounter in production. Synthesizer 1106 and Distributions 1104 are described further below.

At 1114, a number of items are set, such as Bill of Materials, Resources, Machines, Configurations, Compatibilities, Dependencies, and so forth. The information related to the items at 1114 is static information, in that the status of these items does not going to change all that often.

At 1102, the Data Profiler, at the training stage, generates data to train an RL Agent. The Data Profiler can generate Distributions 1104, which are sampled by a Synthesizer 1106. in order to set up a calendar, inventory, orders, and the like, at block 1108. As an example of setting up a calendar, if the machine is known to shut down once in every three days (this information is incorporated into the Distributions 1104), then the synthesizer can create scenarios in which the machine is unavailable once every three days. Overall, the calendar, inventory, orders, and the like, are factory floor settings; as such, these are sampled from the Distributions 1104 by the synthesizer. and the other set is from the user preferences the objectives. The Synthesizer also sets preferences (affinities) and objective rewards at block 1110.

Whereas information related to Bill of Materials, Resources, Machines, Configurations, Compatibilities, Dependencies, and so forth, are static, information related to the calendar, inventory, orders, and the like at block 1108, can be considered as transactional information, as it keeps changing with every planning run, every planning run. Furthermore, the information in block 1108 (calendar, inventory, orders, and the like) are not based on human input, but rather, on a supply planning system that provides this formation.

In some instances, as part of an overall supply chain solution, there can be a demand optimization, where the demand is estimated. This can be followed by supply planning which may plan how to meet the demand. This supply planning, however, is at a very high level, in that it can create monthly orders, or perhaps at most, at a weekly level. Following supply planning is a scheduling system which takes that high level supply plan and breaks it down further into a scheduling output. Information about calendars, inventory, orders and the like (at block 1108) are all ultimately provided from other systems like an ERP or a or the supply upstream supply planning system and so on.

On the other hand, preferences, objectives and rewards (at block 1110) may all be based on human input. The information at block 1110, like that at block 1108, is also dynamic, in that it may change from run to run.

The items at block 1108, block 1110 and block 1114 are then sent to initialize the initializer at 1112, which in turn, initializes the environment (or “env”) at 1116. The environment has a state 1132, which is communicated to the RL Agent 1118. Based on the state 1132, the RL Agent 1118 recommends an Actions 1136 to the environment at 1116. Once the action is executed, the state 1132 of the environment changes. The new state 1132, and a reward 1134 (based on the efficacy of the action are sent to the RL Agent.

After receiving the state and the reward, RL Agent then updates an existing policy at 1120. A policy is a mapping between state and reward. Therefore, the policy is updated based on the state 1132 and reward 1134 received by the RL Agent 1118. This is further elaborated in FIG. 12.

The training count step is incremented at 1122. At decision block 1124, the state of the environment is checked. The result can be one of the following three: “done”, “in-progress” and “truncated”.

“Done” means the environment has successfully executed the order and produced a schedule. The agent then resets the environment, and prepares for next scheduling. If the order scheduling fails, the environment enters the ‘Truncated’ state, prompting the agent to reset the environment and take another attempt at scheduling the order. “Truncated” means the order cannot be completed from the current environment state. “In-Progress” means that scheduling is not complete and the RL agent must choose the next action to play.

If at decision block 1124, the state of the environment is still ongoing (that is, “in progress”), then the system reverts to the RL Agent 1118, which then recommends a new action 1136, based on the most recent received state, to the environment. This in turn, leads to a new state (1132) and associated Reward 1134 that is returned to the RL Agent 1118, leading to an updated policy at 1120, and so on, until decision block 1124 is eventually done or truncated.

On the other hand, if at decision block 1124, the state of the environment is unsuccessful (that is, “truncated” 1140), then the system resets the environment at 1126; and the environment and RL Agent interact once more.

If after decision block 1124, the state is “done” (1138), subsequent decision block 1128 checks to see if further training is to be performed (that is, whether the current training step count has exceeded a pre-configured maximum). If the current training step count has exceeded a pre-configured maximum, training ends at 1130. If the current training step count is less than the pre-configured maximum, then training continues by reverting to the Synthesizers 1106 to provide a new set of environments for training the RL agent.

FIG. 12 illustrates Training mode of an environment in accordance with one embodiment. Training mode is where the RL agent is trained and a policy is learned based on the experience acquired during training. Synthesizer 1202 samples few initializer parameters from a Distribution 1204; this serves as training data to train the RL Agent 1206.

Synthesizer 1202 samples the distribution data (1204) provided by the data profiler, and sends order instances to the Environment 1208. The RL Agent 1206 and Environment 1208 interact; RL Agent 1206 keeps updating its current policy based on that interaction.

The RL Agent 1206 can utilize a machine learning framework such as DQN or PPO, to interact with the Environment 1208 and learn a policy for scheduling these jobs efficiently. DQN supports discrete actions, whereas PPO can be used to implement continuous actions.

FIG. 13 illustrates inference mode of a reinforcement-learning agent in accordance with one embodiment.

After training the RL agent using the synthesizer (for example, Synthesizer 1106 in FIG. 11), the trained RL agent is used to perform schedule in a live environment. This is referred to as “inference mode”.

Inference mode begins at block 1302, block 1304 and block 1306. At block 1302, a number of items are set, such as Bill of Materials, Resources, Machines, Configurations, Compatibilities, Dependencies, and so forth. At block 1304, the calendar, inventory and orders are set. At block 1306, the Data Profiler sets preferences (affinity) and objective rewards.

The items at block 1302, block 1304 and block 1306 are then sent to initialize the initializer at 1310, which in turn, initializes the environment (or “env”) at 1312. The live environment then interacts with the trained RL Agent at 1344, by sending a state 1314 of the live environment to the RL Agent, which in turn recommends an Action 1316 to the Environment, which in turn returns a new state 1314 and a Reward 1318 to the RL Agent. This is further elaborated in FIG. 14.

At decision block 1320, the status of the environment is evlauated, as either “done” (1328), “truncated” (1326) or “in-progress” (1324).

“Done” means the environment has successfully executed the order and produced a schedule at 1330. The agent then resets the environment, and prepares for next scheduling. If the order scheduling fails, the environment enters the ‘Truncated’ state, prompting the agent to reset the environment and take another attempt at scheduling the order. “Truncated” means the order cannot be completed from the current environment state. “In-Progress” means that scheduling is not complete and the RL agent must choose the next action to play.

If the status of the environment (decision block 1320) is “in-progress” (1324), the system reverts to the RL Agent at block 1344, which may take an action 1316, which might change the state 1314 to “Done” or “Truncated”.

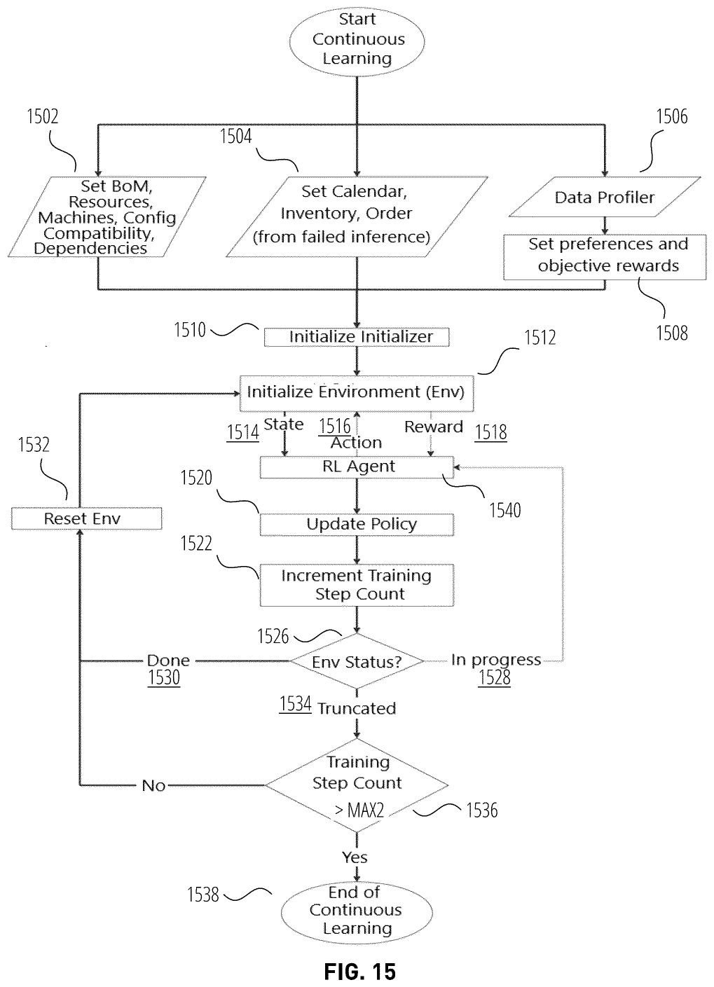

On the other hand, if the status of the environment (decision block 1320) is “truncated” (1326), then the system proceeds to continuous learning mode (1322), which is described further in FIG. 15.

If the status of the environment (decision block 1320) is “done” (1328), one or more schedules are output at block 1330 to a user. The user can then either select a schedule (1338) as is or edit a schedule (1334).

If the user edits a schedule (1334), the edited schedule becomes a pinned task in the initializer (see pinned task 456 in FIG. 4 or FIG. 6); the pinned task is updated at block 1336, and system reverts to initializing the initializer at block 1310. A pinned task can be described within the context of editing a schedule, as follows: the user has edited the schedule such that a particular job has been assigned to a machine-this job is a pinned task. This implies that this particular task is pinned by the RL Agent, while other tasks can be moved around. Once the schedule is edited, and the pinned task is updated at 1336, the process reverts to initialize the initializer at 1310. The process is repeated, beginning at 1312, until the user selects a schedule that is output at 1338.

On the other hand, if the user selects a schedule (1338), then the preferences, objective rewards and order distribution are updated in the Data Profiler at block 1340. The order distribution is used in future retraining of the RL Agent via the Synthesizer (see, for example, FIG. 9). After block 1340, the inference mode ends at 1342.

As an example of preferences used for retraining, there can be a job which can be scheduled using either one of two machines (M1 or M2). However, the user always selects a schedule where that job is scheduled on M2. The user prefers that job to be done using M2. The RL Agent can pick up this preference over time, while it is being retrained. That is, although the job can be completed using either M1 or M2, there is a greater reward for completing the job on M2 (based on user preference).

FIG. 14 illustrates Inference mode of an environment in accordance with one embodiment. Inference mode refers to where the RL Agent 1402 leverages the Policy 1404 it learned during training to perform scheduling on a query order1406 and returns a set of possible schedules 1408 against the query order 1406.

FIG. 15 illustrates continuous learning mode of a reinforcement-learning agent in accordance with one embodiment.

Continuous Learning refers to a situation where the RL Agent, trained based on sampling different environments, encounters a live environment for which it was not trained. In that case, the inference mode in FIG. 13 attains an environment status (at decision block 1320) that is truncated (1326). At this point, the system tries to learning from this environment via the continuous learning mode illustrated in FIG. 15.

Continuous learning mode begins at block 1502, block 1504 and block 1506. At block 1502, a number of items are set, such as Bill of Materials, Resources, Machines, Configurations, Compatibilities, Dependencies, and so forth. At block 1504, the calendar, inventory and orders (from the failed inference) are set. At block 1506, the Data Profiler sets preferences (affinity) and objective rewards.

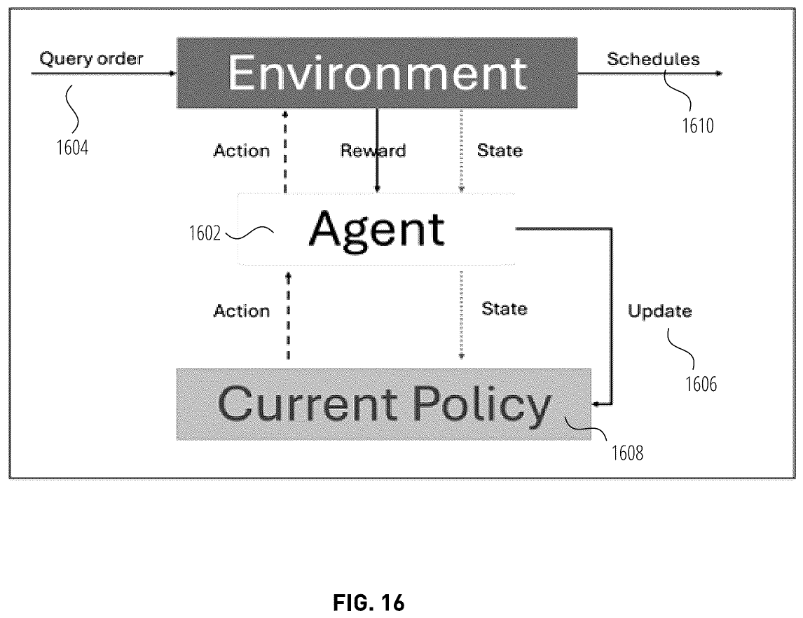

The items at blocks 1502, 1504 and 1506 are then sent to initialize the initializer at block 1510, which in turn, initializes the environment (or “env”) at 1512. The environment then interacts with the RL Agent at 1540, by sending a state 1514 of the environment to the RL Agent, which in turn replies with an Action 1516 to the Environment, which in turn replies with a Reward 1518 to the RL Agent. The RL Agent then updates an existing policy at 1520 (based on the exchange of state 1514, action 1516 and reward 1518). This is further elaborated in FIG. 16.

A key difference between the inference mode illustrated in FIG. 13 and the continuous learning mode illustrated in FIG. 15, is that the continuous learning mode has a step to update policy (1520), whereas the inference mode has no such step.

In both an inference and continuous modes, the order is fixed, and the environment is fixed. In the inference mode, the system relies on a previous policy. In the continuous learning mode, the environment is fixed and then the policy is updated so that the RL Agent is trained better address that environment. That is, that environment state is added to the knowledge base.

The training count step is incremented at 1522. At decision block 1526, the state of the environment is checked. The result can be one of the following three: “done” (1530), “in-progress” (1528) and “truncated” (1534). Recall, from above, that:

“Done” means the environment has successfully executed the order and produced a schedule. The agent then resets the environment, and prepares for next scheduling. If the order scheduling fails, the environment enters the ‘Truncated’ state, prompting the agent to reset the environment and take another attempt at scheduling the order. “In-Progress” means that scheduling is not over and the RL agent must choose the next action to play. “Truncated” means the order cannot be completed from the current environment state.

If the status of the environment (decision block 1526) is “done” (1530), the environment is reset at block 1532, and the system reverts to initializing the environment at block 1512.

If the status of the environment (decision block 1526) is “in-progress” (1528), the system reverts to the RL Agent at block 1540, which may take an action 1516, which might change the state 1514 to “Done” or “Truncated”.

On the other hand, if the status of the environment (decision block 1522) is “truncated” (1534), then the subsequent decision block 1536 checks to see if further training is to be performed (that is, whether the current training step count has exceeded a pre-configured maximum). The pre-configured maximum (MAX2) at 1536, is different from the pre-configured maximum at 1128 in FIG. 11 of the Training Mode. MAX2 is several orders of magnitude less than MAX.

If the current training step count has exceeded a pre-configured maximum, continuous learning ends at 1538. If the current training step count is less than the pre-configured maximum, then continuous learning continues by reverting to block 1106 1532 where the environment is reset, followed by initializing the environment at block 1512.

FIG. 16 illustrates Continuous Learning mode of an environment in accordance with one embodiment. The RL Agent 1602 sometimes can encounter a Query order 1604 which it might not be able to successfully schedule. This can be due to many reasons, such as insufficient training or an outlier query. An “outlier query” refers to a situation where the RL agent has been trained on a distribution of data, while a subsequent query is outside of the distribution.

In cases where the RL Agent 1602 encounters a Query order 1604 which it cannot successfully schedule, the RL Agent 1602 can enter a continuous learning mode wherein the RL Agent 1602 makes updates 1606 to its current policy 1608 and expands its capabilities to successfully generate new schedules 1610 the new Query order 1604. This is illustrated in FIG. 16. Continuous learning mode allows for RL Agent 1602 to update its policy so that it can newly schedule the incoming order that it was not able to schedule previously.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computing apparatus comprising:
a processor; and
a memory storing instructions that, when executed by the processor, configure the apparatus to:
train a reinforcement-learning agent using synthetic training data;
initialize a live environment comprising a dynamic graph representation of scheduling dependencies;
execute an inference mode wherein the reinforcement-learning agent generates schedules based on environmental states and learned policies;
receive user feedback on generated schedules;
update a data profiler with transactional data and user preferences; and
retrain the reinforcement-learning agent based on the updated data.

2. The computing apparatus of claim 1, wherein the live environment comprises a graph representation with:
nodes representing machines and jobs;
edges representing compatibility, dependencies, and scheduling constraints; and
attributes comprising: machine availability; job status; and time.

3. The computing apparatus of claim 1, wherein the reinforcement-learning agent receives rewards based on at least one of:
minimizing idle machine time;
minimizing job wait time;
adherence to due dates; and
minimizing changeover time.

4. The computing apparatus of claim 1, wherein the user feedback comprises at least one of:
selection of preferred schedules;
edits to job-machine assignments; and
pinning of tasks to specific machines.

5. The computing apparatus of claim 1, further configured to:
detect a truncated inference state;
enter a continuous learning mode; and
update the reinforcement-learning agent's policy based on the failed environment instance.

6. A non-transitory computer-readable storage medium storing instructions that, when executed by a processor, cause the processor to:
train a reinforcement-learning agent using synthetic data;
provide a live environment to the reinforcement-learning agent for inference;
generate one or more schedules based on the live environment;
receive user feedback on the schedules;
update transactional data and user preferences; and
retrain the reinforcement-learning agent using the updated data.

7. The non-transitory computer-readable storage medium of claim 6, wherein the live environment comprises a graph representation with:
nodes representing machines and jobs;
edges representing compatibility, dependencies, and
scheduling constraints; and
attributes comprising: machine availability; job status; and time.

8. The non-transitory computer-readable storage medium of claim 6, wherein the reinforcement-learning agent receives rewards based on at least one of:
minimizing idle machine time;
minimizing job wait time;
adherence to due dates; and
minimizing changeover time.

9. The non-transitory computer-readable storage medium of claim 6, wherein the user feedback comprises at least one of:
selection of preferred schedules;
edits to job-machine assignments; and
pinning of tasks to specific machines.

10. The non-transitory computer-readable storage medium of claim 6, further comprising instructions that, when executed, cause the processor to:
detect a truncated inference state;
enter a continuous learning mode; and
update the reinforcement-learning agent's policy based on the failed environment instance.

11. A computer-implemented method comprising:
training, by a processor, a reinforcement-learning (RL) agent using synthetic data;
providing, by the processor, a live environment to the RL agent, the environment comprising a dynamic graph representation of scheduling dependencies;
entering, by the processor, into an inference mode wherein the RL agent interacts with the live environment to generate one or more schedules;
outputting, by the processor, at least one schedule to a user;
receiving, by the processor, user feedback;
updating, by the processor, transactional data and user preferences based on the user feedback; and
retraining, by the processor, the RL agent using the updated transactional data and preferences.

12. The computer-implemented method of claim 11, wherein the live environment comprises a graph representation with:
nodes representing machines and jobs;
edges representing compatibility, dependencies, and scheduling constraints; and
attributes comprising: machine availability; job status; and time.

13. The computer-implemented method of claim 11, wherein the reinforcement-learning agent receives rewards based on at least one of:
minimizing idle machine time;
minimizing job wait time;
adherence to due dates; and
minimizing changeover time.

14. The computer-implemented method of claim 11, wherein user feedback comprises at least one of:
selection of preferred schedules;
edits to job-machine assignments; and
pinning of tasks to specific machines.

15. The computer-implemented method of claim 11, further comprising:
detecting a truncated inference state;
entering a continuous learning mode; and
updating the reinforcement-learning agent's policy based on the failed environment instance.
